(19) United States
(12) Patent Application Publication
(10) Pub. No.: US 2006/0028909 A1
(43) Pub. Date: Feb. 9, 2006

(54) Device and method for flow mixing of a biological fluid and a solution

(76) Inventor: Maurice Behague, Linselles (FR)

Correspondence Address: BAKER BOTTS, LLP, 910 LOUISIANA, HOUSTON, TX, 77002-4995, US

(21) Appl. No.: 11/196,706

(22) Filed: Aug. 3, 2005

(30) Foreign Application Priority Data
Aug. 3, 2004 (FR) 0451769

(51) Int. Cl. G05D 11/02

(52) U.S. Cl. 366/152.1; 366/160.2; 366/160.5; 417/36; 417/474; 604/47; 137/87.01

(57) ABSTRACT

The disclosure relates to a mixing machine, system, and method including: a measurement device able to measure a volume of a biological fluid; a pumping device able to pump an anticoagulant and/or preservation solution into the biological fluid; and a control system for the pumping device. The control system may include: a device for determining an actual volume of the solution previously pumped by the pumping device and an automatic control able to control a pumping speed of the pumping device. The automatic control may control the pumping speed by calculating a theoretical volume of the solution to be mixed with the biological fluid previously pumped by the pumping device as a function of a determined ratio of the biological fluid collected and the solution pumped; comparing the theoretical volume to the actual volume; and adjusting the pumping speed of the pumping device to approach the determined ratio.

### PRIORITY CLAIM

The present application claims priority under 35 U.S.C. §119(d) to French Application Serial Number 0451769, filed Aug. 3, 2004, titled “Flow mixing machine and method according to a determined ratio of biological fluid and a solution”. This French priority application is incorporated by reference herein.

### TECHNICAL FIELD

The invention relates to a machine for flow mixing a determined ratio of a biological fluid and solution, such as an anticoagulant and/or preservation solution, as well as a mixing process using such a machine. In particular embodiments, it may the biological fluid may be whole blood to be collected from a donor in a collection bag. The blood may be collected in a sterile manner and mixed with and anticoagulant and/or preservation solution at the time it is collected to provide health safety benefits during subsequent use.

### BACKGROUND

When collecting a biological fluid, it is difficult to obtain a determined ratio between the quantity of fluid collected and the quantity of anticoagulant and/or preservation solution. This is a particular problem in the field of blood collection where the quantity of anticoagulant and/or preservation solution found in the collection bag is set at a certain value so that the blood can be used medically.

EP 0 583 148 teaches a device to introduce a flow of medical fluid into a flow of biological fluid. The device includes a component designed to receive a volume signal, to calculate a speed of volume change and to adjust the flow of medical fluid according to the change in speed calculated.

This type of strategy to obtain a determined ratio of medical fluid in a biological fluid is not fully satisfactory. Flow of the medical fluid cannot be set properly because of low volume measurement resolution using the instruments provided.

Therefore, the operator has two possible options for this type of machine:

use a big period of measurement to be able to obtain the variation in volume in a relatively exact manner, but then the adjustment of the flow of the medical fluid is not frequent enough to satisfactorily correspond with the flow of biological fluid. In particular, if there is a high variation in the flow of the biological fluid, the medical fluid may be provided too quickly, and the ratio is not preserved over time in a satisfactory manner;

use a smaller period of measurement in order to try to better preserve the ratio over time even though the precision of the measurement of the variation in volume is too low to obtain a satisfactory adjustment of the flow of the medical fluid. In particular, the operator may then observe instabilities in the adjustment, which overly taxes the machine and, despite the effort, the ratio is not maintained over time.

### SUMMARY

The invention relates to a machine for flow mixing a determined ratio of a biological fluid and solution, such as an anticoagulant and/or preservation solution, as well as a mixing process using such a machine.

In one embodiment, the invention relates to a mixing machine including a measurement device able to measure a volume of a biological fluid collected by natural flow. It may also include a pumping device able to pump an anticoagulant and/or preservation solution into the biological fluid. It may also include a control system for the pumping device. The control system may include a device for determining an actual volume of the anticoagulant and/or preservation solution previously pumped by the pumping device into the biological fluid and an automatic control means operable to control a pumping speed of the pumping device. The automatic control means controls the pumping speed by calculating a theoretical volume of the anticoagulant and/or preservation solution to be mixed with the biological fluid previously pumped by the pumping device as a function of a determined ratio of the biological fluid collected and the anticoagulant and/or preservation solution pumped; comparing the theoretical volume to the actual volume; and adjusting the pumping speed of the pumping device to approach the determined ratio.

In another embodiment, the invention relates to a mixing system including a measurement device able to measure a volume of a biological fluid collected by natural flow. It may also include a pumping device able to pump an anticoagulant and/or preservation solution into the biological fluid. It may also include a control system operable to control the pumping device. The control system includes a device able to determine an actual volume of the anticoagulant and/or preservation solution previously pumped by the pumping device into the biological fluid and an automatic control device. The automatic control device may be able control a pumping speed of the pumping device; calculate a theoretical volume of the anticoagulant and/or preservation solution to be mixed with the biological fluid previously pumped by the pumping device as a function of a determined ratio of the biological fluid collected and the anticoagulant and/or preservation solution pumped; compare the theoretical volume to the actual volume; and adjust the pumping speed of the pumping device to approach the determined ratio.

In yet another embodiment, the invention relates to a method for mixing a biological fluid and an anticoagulant and/or preservation fluid. The method may include: measuring a volume of the biological fluid collected; adding anticoagulant and/or preservation fluid to the biological fluid using a pump; calculating a theoretical volume of anticoagulant and/or preservation fluid to be added to the volume of biological fluid based on a determined ratio; determining an actual volume of anticoagulant and/or preservation fluid added to the biological fluid collected; comparing the theoretical volume and actual volume; and adjusting a pump speed of the pump based on the comparison, so as to approach the determined ratio between the volume of biological fluid collected and the volume of anticoagulant and/or preservation solution added.

### BRIEF DESCRIPTION OF THE DRAWINGS

The following figures form part of the present specification and are included to further demonstrate certain aspects of the present invention. The invention may be better understood by reference to one or more of these drawings in combination with the detailed description presented herein.

FIG. 1 illustrates a mixing machine and method according to a first embodiment in which only the collection bag is placed on a weight measurement device.

FIG. 2 illustrates a mixing machine and method according to another embodiment in which the collection bags and anticoagulant and/or preservation solution bags are placed on a weight measurement device.

FIG. 3 is a perspective view of a mixing machine according to one embodiment.

### DETAILED DESCRIPTION

The invention relates to a machine for flow mixing a determined ratio of a biological fluid and solution, such as an anticoagulant and/or preservation solution, as well as a mixing process using such a machine.

Embodiments of the invention solve one or more problems of some previous mixing machines and methods. In particular, embodiments of the invention may provide a better ability to preserve the determined ratio of biological fluid and an anticoagulant and/or preservation solution during mixing. This may be accomplished using instruments with a standard resolution.

Accordingly, some embodiments may relate to a machine for flow mixing a determined ratio of a biological fluid, in particular blood, and an anticoagulant and/or preservation solution. The machine may include a measurement device able to measure the volume of a biological fluid that is collected by natural flow, a pumping device for the anticoagulant and/or preservation solution, and a control system of the pumping device. The control system may include a device to determine the volume of solution pumped and an automatic control device for the speed of pumping. The automatic control device may be able to calculate the theoretical volume of solution to mix with the volume of biological fluid collected, based on a determined ratio. It may compare the theoretical volume of solution and the actual volume of solution pumped. It may then adjust the pump speed as a function of the previous comparison so as to approach the determined ratio between the quantity of biological fluid collected and the quantity of anticoagulant and/or preservation solution mixed.

Other embodiments relate to a method to mix a determined ratio of biological fluid and an anticoagulant and/or preservation solution in closed circuit. A machine such as one described above may be used. A system of bags in closed circuit may also be employed. These bags may include a device to collect the fluid, a bag containing an anticoagulant and/or preservation solution for the fluid collected, and a collection bag made to receive the fluid collected which may be mixed with the anticoagulant and/or preservation solution. The collection bag may be in fluid communication with the device to collect the fluid through a first soft tube. The collection bag may also be in fluid communication with a bag containing the anticoagulant and/or preservation solution through a second soft tube.

The method may include the following steps, which may be repeated:

measuring the volume of fluid collected in the collection bag;

determining the volume of solution pumped from the bag containing solution;

calculating the theoretical volume of solution to be mixed with the volume of fluid collected as a function of a determined ratio;

comparing the theoretical volume of solution and the volume of solution pumped;

adjusting the pump speed according to the previous comparison in order to approach the determined ratio between the quantity of fluid collected and the quantity of anticoagulant and/or preservation solution mixed.

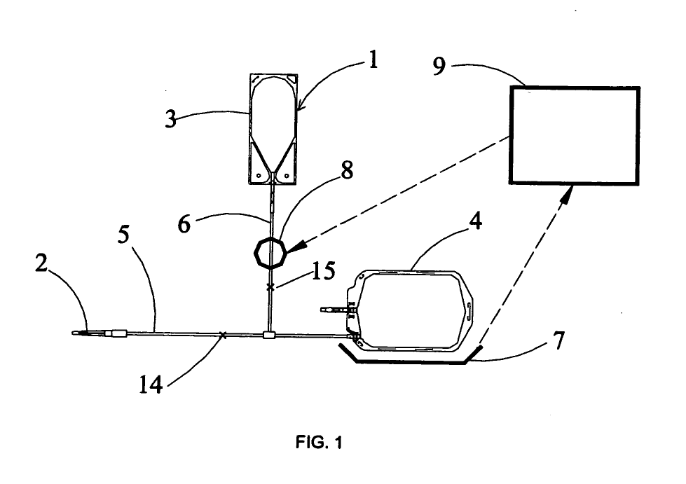

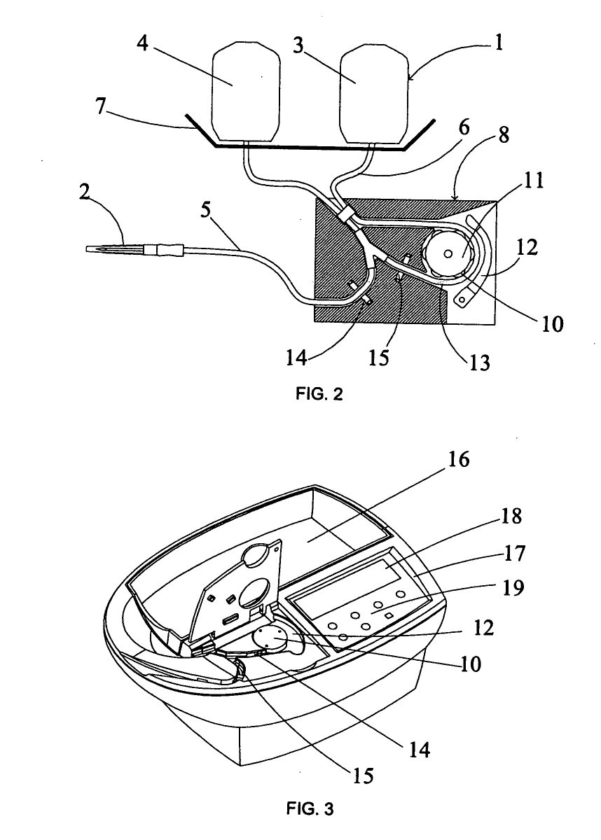

FIGS. 1 and 2 illustrate a machine and method for flow mixing a determined ratio of a biological fluid and an anticoagulant and/or preservation solution, according to embodiments of the present invention.

In particular embodiments, the biological fluid may be a blood fluid such as whole blood taken from a donor and the anticoagulant and/or preservation solution may be a solution including CPD (citrate phosphate dextrose), CP2D (cirate phosphate 2 dextrose) or CDA (citrate dextrose acid). In general, the determined ratio between the quantity of anticoagulant and/or preservation solution and the quantity of whole blood may be 1:7. However, this ratio may vary according to the geographic regions in which the blood is collected.

According to the embodiments show in FIGS. 1 and 2, the biological fluid may be collected from a donor by natural flow. The fluid and anticoagulant and/or preservation solution may be mixed with the biological fluid using collection system 1, collecting device 2, bag 3 in which anticoagulant and/or preservation solution is located, and collection bag 4 intended to receive the biological fluid collected mixed with the anticoagulant and/or preservation solution. Collection bag 4 may be in fluid communication with collecting device 2 through first soft tube 5 and with bag 3 containing the anticoagulant and/or preservation solution through second soft tube 6.

The collecting device 2 in particular embodiments may include a needle providing access to the donor's vein. In this case, the fluid may be directly collected from the donor. The fluid may be collected by natural flow, that is, based on the venous pressure and/or gravity. This system for collection may provide greater comfort and safety for the donor.

In FIGS. 1 and 2, all of the elements of collection system 1 may be pre-connected so as to form a closed unit or closed circuit system. The system thereby formed may be sterilized and packaged in sterile and ready-to-use packaging.

In an embodiment not explicitly shown, the biological fluid to be mixed may be contained in a transfer bag. In this embodiment, the collecting device 2 may include a perforator that can be connected to an outlet valve in the transfer bag containing the biological fluid. The biological fluid may be collected from the transfer bag by natural flow, for example by gravity.

According to FIGS. 1 and 2, the mixing machine may include a measurement device 7 for measuring the volume of fluid collected by natural flow, a pumping device 8 for the anticoagulant and and/or preservation solution and a control system 9 for the pumping device.

Measurement device 7 may indicate, at all times, the total volume of the fluid collected by natural flow.

According to the design shown in FIG. 1, measurement device 7 for measuring the volume of fluid collected includes a device for measuring the weight of fluid collected, such as a scale and a device for calculating the corresponding volume. The volume of fluid may be calculated based on the weight using the density of the fluid, which is generally known.

According to FIG. 2, the entire collection system 1 is placed on placed on the scale, in order to take into account the weight of the aforementioned bag system before mixing. Because the anticoagulant and/or preservation solution then moves from anticoagulant and/or preservation solution bag 3 to collection bag 4, and these two bags are both on the scale, only the weight of the fluid collected is measured.

If only collection bag 4 is placed on the scale (as shown in FIG. 1), it may be necessary to take into account the tare normally obtained in addition to a constant which is the variation in weight related to the introduction of the anticoagulant and/or preservation solution into collection bag 4.

As shown in FIG. 2, the pumping device may include a peristaltic pump 10 with a single head 11 that is mobile in rotation at variable speeds.

The mixing machine may also include a placement device 12, around part of head 11, and a flow loop 13 for the solution so as to allow the circulation of the solution by partial compression of a zone in the aforementioned loop.

The flow loop may be formed by a part of the second tube 6 connecting anticoagulant and/or preservation solution bag 3 to collection bag 4.

This loop may be pre-formed as in the system of bags described in European patent application EP 1 442 759.

According to embodiments of the invention, the control system 9 may include a device for determining the volume of the solution pumped and an automatic control device for the pumping speed.

The device for determining the volume may provide, from of the beginning of mixing, the total volume of the anticoagulant and/or preservation solution at all times.

According to FIG. 2, the device for determining the volume of solution pumped may include a device for determining the number of revolutions carried out by head 11 of peristaltic pump 10 and a device for calculating the volume pumped corresponding to the aforementioned number of revolutions.

The device for measuring the volume of fluid collected or the device for determining the volume of solution pumped may determine all parameters of the fluid or the solution, from which a volume may be calculated using an algorithm. For example, the device for measuring the volume or determining the volume may detect a mass, a flow, a height in a bag, a pressure and/or a deformation.

Thereby, the device may include optical detectors, flow sensors, pressure sensors, etc.

In particular embodiments, the device for measuring the volume of the fluid collected or the device for determining the volume of the solution pumped may maintain the sterility of the collection system.

Control system 9 according to embodiments of the invention may also include an automatic control device for the pumping speed, for example, in the form of a computer. The automatic control device may be operable to:

calculate the theoretical volume of the solution to be mixed with the volume of fluid collected as a function of a determined ratio;

compare the theoretical volume of solution and the volume of solution pumped; and

adjust the pump speed as a function of the previous comparison so as to approach the determined ratio between the quantity of fluid collected and the quantity of anticoagulant and/or preservation solution mixed.

The automatic control device for the pump speed may control the speed of the pumping device according to the theoretical volume of the solution and the volume of the pumped solution. For example, the automatic control device may control the motor of pump 10.

In yet another embodiment, optical sensors 14 15 may be added to the machine. A first optical sensor 14 may be placed on first tube 5. This sensor may detect the presence of fluid, in order to verify that the fluid circulates suitably within first tube 5. It may also verify that no air or anticoagulant and/or preservation solution rises up to collecting device 2. Optical sensor 14 may also, for example, be replaced or complemented with an ultrasound sensor used to more finely detect inversions of flow.

A second optical sensor 15 may be placed on second tube 6. This sensor may detect the presence of anticoagulant and/or preservation solution in order to verify that the anticoagulant and/or preservation solution circulates suitably within second tube 6.

FIG. 3 represents a view in perspective of a machine for mixing blood and anticoagulant and/or preservation solution, according to an embodiment of the invention. The mixing machine may include a device to measure the weight of the fluid collected in the form of scale 16, a peristaltic pump 10, and a control system for the peristaltic pump as described above.

The machine may also include interface 17 for a user having display 18 and keyboard 19.

The machine may also include a placement device 12 around part of head 11 and a flow loop for the solution so as to enable the circulation of the solution by partial constriction of a zone of the aforementioned loop.

According to a another embodiment, the invention may include a process to mix a determined ratio of biological fluid and an anticoagulant and/or preservation solution in a closed circuit using a machine as described above.

The method may specifically include the use of a collection system 1 such as described in relation to FIG. 1. Collection system 1 may include, in a closed circuit, collecting device 2, bag 3 containing an anticoagulant and/or preservation solution for the fluid collected, and collection bag 4 intended to receive the fluid collected mixed with the anticoagulant and/or preservation solution. Collection bag 4 may in fluid communication with collection device 2 through first soft tube 5 and with bag 3 containing the anticoagulant and/or preservation solution through second soft tube 6.

The method may include the following iterative stages, which may be repeated:

measuring of the volume of biological fluid collected in collection bag 4;

determination of the volume of the solution pumped from bag 3;

calculating the theoretical volume of the solution to be mixed with the volume of fluid collected based on the determined ratio;

comparing the theoretical volume of the solution and the volume of solution actually pumped;

adjusting the pump speed as a function of the previous comparison so as to approach the ratio determined between the quantity of fluid collected and the quantity of anticoagulant and/or preservation solution mixed.

The volume of fluid collected may be measured using at least collection bag 4 placed on a weight measurement device. Volume may then be calculated as corresponding to the weight measured.

Related to the mixing machine illustrated in FIG. 3, the collection bag and the anticoagulant and/or preservation solution bag may be placed on scale 16. The scale thereby directly determines the weight of the fluid collected. The conversion of the weight of the fluid collected into volume of fluid collected may be calculated by means of the density of the blood.

This volume of fluid collected may be used to calculate a theoretical volume of solution as a function of the determined ratio.

In parallel, the volume of solution pumped may be determined by the determination device and, in particular, using the number of revolutions of the head of pump 11 of peristaltic pump 10.

The difference between the theoretical volume of solution and the volume of solution pumped may be calculated and the pump speed may be adjusted by application of a pump speed that is a function of this difference.

For example, if the difference is negative, this means that too much solution was pumped with respect to the quantity of fluid collected. The pumping may then be interrupted.

If the difference is positive, this means that not enough solution was pumped and more pumping may take place. The pumping speed may be determined as a function of this difference. The greater the difference, the more the speed may be increased to make up for the lack of anticoagulant and/or preservation solution in the collection bag with respect to the fluid collected.

In one embodiment, the theoretical volume of the solution calculated from the volume of fluid collected may be transcribed in theoretical number of revolutions of the head of the peristaltic pump.

The number of revolutions actually carried out by the pump head may be compared with this theoretical number of revolutions of the pump head and the pump speed may be adjusted as a function of the previous comparison.

These iterative stages may be carried out with a sampling period ranging from 1 and 5 seconds, in particular 3 seconds.

This sampling period may be sufficiently long for a sufficient variation in the volume of the fluid collected to be detected in a precise manner and sufficiently short to obtain quasi continuously the determined ratio between the quantity of anticoagulant and/or preservation solution mixed.

Therefore, even if the mixing is interrupted for any reason before the end of the procedure, the determined ratio may be maintained. In the case of blood collection, the loss of this ratio may lead to a drop in the quality of the blood by lysis of the erythrocytes and a deterioration of the functionality of the platelets, rendering the blood unusable.

The machine and the associated method may be especially adapted for the collection of blood from a donor in which the volume of fluid collected increases in an increasing manner with a limited flow, as is the case when whole blood is collected by natural flow.

The method may avoid fast changes in the pump speed.

Although only exemplary embodiments of the invention are specifically described above, it will be appreciated that modifications and variations of these examples are possible without departing from the spirit and intended scope of the invention.

1. A mixing machine comprising:
a measurement device operable to measure a volume of a biological fluid collected by natural flow;
a pumping device operable to pump an anticoagulant and/or preservation solution into the biological fluid; and
a control system for the pumping device, the control system including:
a device for determining an actual volume of the anticoagulant and/or preservation solution previously pumped by the pumping device into the biological fluid; and
an automatic control means operable to control a pumping speed of the pumping device;
wherein the automatic control means controls the pumping speed by:
calculating a theoretical volume of the anticoagulant and/or preservation solution to be mixed with the biological fluid previously pumped by the pumping device as a function of a determined ratio of the biological fluid collected and the anticoagulant and/or preservation solution pumped;
comparing the theoretical volume to the actual volume; and
adjusting the pumping speed of the pumping device to approach the determined ratio.

2. A mixing machine according to claim 1, wherein the measurement device comprises a weight measurement device.

3. A mixing machine according to claim 1, wherein the measurement device comprises a weight measurement means and a means for calculating the volume of a biological fluid collected by natural flow based on weight.

4. A mixing machine according to claim 1, wherein the pumping device comprises a peristaltic pump having a single head that is mobile in rotation at variable speeds.

5. A mixing machine according to claim 4, wherein the automatic control means comprises:
a means for determining the number of revolutions made by the head; and
a means for calculating the actual volume based on the number of revolutions.

6. A mixing machine according to claim 4, further comprising:
a placement device around part of the head; and
a flow loop operable with the head and placement device to move the solution through the loop by constriction of a zone of the flow loop.

7. A mixing machine according to claim 1, wherein the biological fluid comprises blood or a blood component.

8. A mixing system comprising:
a measurement device operable to measure a volume of a biological fluid collected by natural flow;
a pumping device operable to pump an anticoagulant and/or preservation solution into the biological fluid; and
a control system operable to control the pumping device, the control system including:
a device operable to determine an actual volume of the anticoagulant and/or preservation solution previously pumped by the pumping device into the biological fluid; and
an automatic control device operable to:
control a pumping speed of the pumping device;
calculate a theoretical volume of the anticoagulant and/or preservation solution to be mixed with the biological fluid previously pumped by the pumping device as a function of a determined ratio of the biological fluid collected and the anticoagulant and/or preservation solution pumped;
compare the theoretical volume to the actual volume; and
adjust the pumping speed of the pumping device to approach the determined ratio.

9. A mixing system according to claim 8, wherein the measurement device comprises a device operable to weigh the biological fluid.

10. A mixing system according to claim 8, wherein the measurement device comprises a device operable to calculate the volume of a biological fluid collected by natural flow based on weight.

11. A mixing system according to claim 8, wherein the pumping device comprises a peristaltic pump having a single head that is mobile in rotation at variable speeds.

12. A mixing system according to claim 11, wherein the automatic control device comprises:
a component operable to determine the number of revolutions made by the head; and
a component operable to calculate the actual volume based on the number of revolutions.

13. A mixing system according to claim 11, further comprising:
a placement device around part of the head; and
a flow loop operable with the head and placement device to move the solution through the loop by constriction of a zone of the flow loop.

14. A mixing machine according to claim 8, wherein the biological fluid comprises blood or a blood component.

15. A method for mixing a biological fluid and an anticoagulant and/or preservation fluid comprising:
measuring a volume of the biological fluid collected;
adding anticoagulant and/or preservation fluid to the biological fluid using a pump;
calculating a theoretical volume of anticoagulant and/or preservation fluid to be added to the volume of biological fluid based on a determined ratio;
determining an actual volume of anticoagulant and/or preservation fluid added to the biological fluid collected;
comparing the theoretical volume and actual volume; and
adjusting a pump speed of the pump based on the comparison, so as to approach the determined ratio between the volume of biological fluid collected and the volume of anticoagulant and/or preservation solution added.

16. A method according to claim 15, further comprising:
using a collection device in a closed circuit collection system to obtain the biological fluid;
collecting the biological fluid in a collection bag in the closed circuit collection system; and
removing the anticoagulant and/or preservation solution from a solution bag in the closed circuit collection system using the pump.

17. A method according to claim 16, wherein measuring a volume of the biological fluid collected comprises:
placing the collection bag on a weight measurement device; and
calculating the volume of fluid corresponding to the weight measured.

18. A method according to claim 15, wherein comparing comprises determining a difference between the theoretical volume and the actual volume.

19. A method according to claim 15, further comprising repeating the steps in multiple iterations.

20. A method according to claim 19, wherein each iteration lasts between 1 and 5 seconds.

21. A method according to claim 15, wherein the biological fluid comprises blood or a blood component.
